(19) United States
(12) Patent Application Publication
(10) Pub. No.: US 2009/0067361 A1
(43) Pub. Date: Mar. 12, 2009

(54) Cellular Phone Signal Enhancement Apparatus

(76) Inventor: Joseph N. Califano, (US)

Correspondence Address: JOSEPH N. CALIFANO, 6449 OAK SHORE DRIVE, PANAMA CITY, FL, 32404, US

(21) Appl. No.: 11/852,281

(22) Filed: Sep. 8, 2007

(51) Int. Cl. H04B 7/14

(52) U.S. Cl. 370/315

(57) ABSTRACT

A method for guiding radio frequency (RF), this apparatus aids an RF signal for receiving incoming and outgoing RF cellular signals is described. This apparatus facilitates an improved communications link between an outside cellular signal source and a receiving indoor hand held cellular device. This apparatus improves existing communication links by providing a path for RF signal travel using standard building wiring infrastructure. This invention, in its preferred embodiments, is specifically designed to provide channeling of RF communications from local sources of RF signal sources outside of a building or other structure to their interior. This invention uses only passive means to facilitate an RF path and is not electrically activated when plugged into a standard wall outlet, but relies on absorbed RF thru existing building wiring infrastructure to facilitate an improved communications signal to a hand held cellular device inside of said structure.

### TECHNICAL FIELD AND TELECOMMUNICATIONS APPLICABILITY OF THE INVENTION

This invention generally relates to wireless communications and more specifically relates to improvement of Radio Frequency signal reception to cell phone's for better reception of a wireless tower transmission signal. This device facilitates an existing outside Radio Frequency signal toward a common portable cell phone device located inside an enclosed structure, such as a large building. According to the preferred embodiments, this lightweight and portable device is plugged into a standard wall socket of a typical building structure for the purpose of using the buildings installed wiring infrastructure to facilitate a Radio Frequency cell phone signal to penetrate into the interior of the building, for which the invented device is plugged into a standard wall outlet, and aids the signal to reach the intended receiving cell phone device. This device uses no electricity from the outlet, only contact with the wiring infrastructure of the building which the device creates a path using the building wiring as a radio frequency medium which forwards the cell signal to a receiving cell phone device.

Wireless communications between electronic devices are becoming more common place. One problem arises that in some situations a wireless device will have some difficulty connecting inside of buildings as the wireless radio signal sometimes has a difficult time penetrating the outside of a standard building to allow for cell signal to reach the intended cell phone receiver inside of said building. There are known signal boosters that will use electrical current to boost a cell phone signals within a structure such as a building. Most are hard wired into a building and are not attractive or sometimes ineffective.

According to the preferred embodiments, this lightweight and portable device is plugged into a standard wall socket of a typical building structure for the purpose of using the buildings installed wiring infrastructure to facilitate a RF cell phone signal to penetrate into the interior of the building, for which the invented device is plugged into a standard wall outlet, and aids the signal to reach the intended cell phone device. This device uses no electricity from the outlet, only contact with the wiring infrastructure of the building which the device creates a path for the building wiring using existing building wiring infrastructure to act as a large antenna to direct to the invention and then which provides a path for cell phone signals from outside of the building to be received into the portable cell phone enhancement device itself which in turns allows weak signals to reach the cell phone device thru this passive means and improve reception of that original signal. The device itself acts as a passive antenna repeater that helps improve incoming RF signal outside of a structure, such as an office building. This in effect will allow incoming cell phone calls which may be weak inside of a building to receive cell phone signals of better strength and quality based solely upon the output power from the cell phone itself and cell tower RF signal itself.

This substitute specification contains no new matter.

### BRIEF DESCRIPTION OF DRAWING

The preferred embodiments of the present invention will hereinafter be described in conjunction with the appended drawings, where like designations denote like elements and:

FIG. 1 is back view of functional invention diagram, shows basic body construction and antenna position.

FIG. 2 is front view of functional invention diagram. Shows basic construction with antenna, also shows layout of outlet interface blades in same conjunction with standard building wall outlet.

FIG. 3 is side view of functional invention diagram, shows basic construction and antenna. Also shows layout of outlet interface blades in conjunction with standard wall outlet relationship.

FIG. 4 is front view of functional invention diagram. Shows basic construction with antenna, also shows basic layout of outlet interface blades in conjunction with standard wall outlet relationship. Also shows internal electronic component layouts

FIG. 5 is detailed schematic diagram showing all electronic components and there connection layouts.

### DETAILED DESCRIPTION OF INVENTION

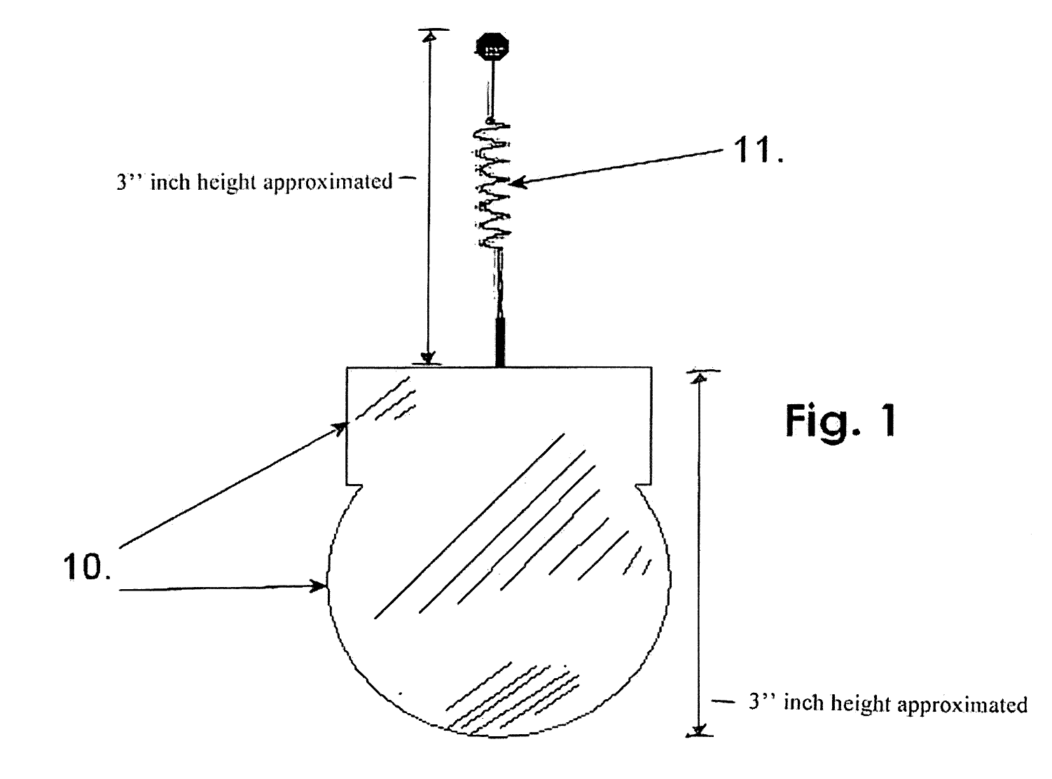

FIG. 1 is back view of physical package of invention, 10 using plastic or plastic type substance, 11 is standard metal cellular antenna which is affixed permanently to the device.

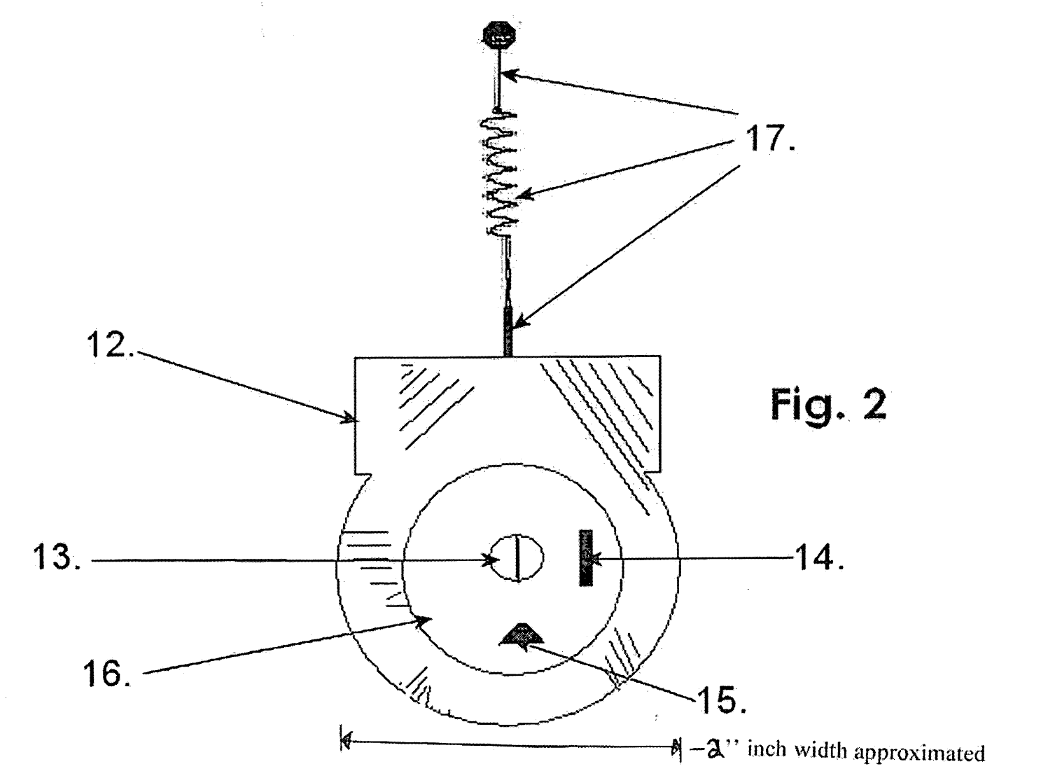

FIG. 2 is the front side view of the physical package that plugs into a standard wall outlet, 17 is standard metal cellular antenna which is affixed permanently to the device. Plastic type substance 12 used for physical body of device. 13 is center screw to secure of internal device plastic cover. 16 is plastic cover of device. 14 is outlet polarized blade that plugs to standard AC wall outlet. 15 is standard ground blade that plugs into standard home AC outlet.

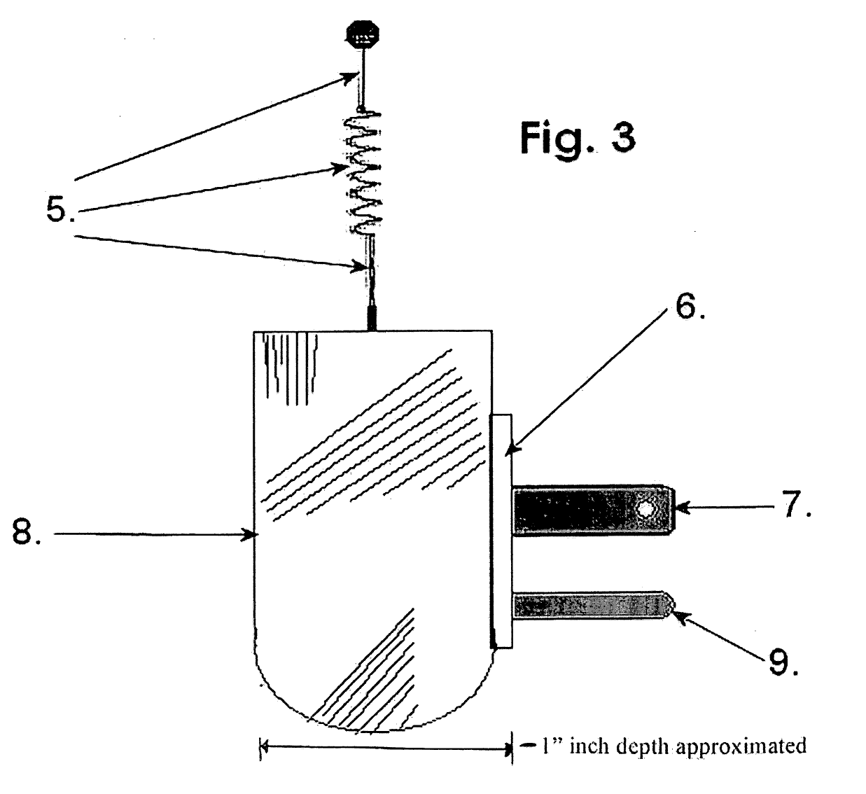

FIG. 3 is a side view of the physical package with 7 polarized outlet blade, 9 is standard grounding blade found on most typical AC outlets. 8 Physical package of device using a plastic or plastic type construction material. 5 is standard metal cellular antenna which is permanently affixed to the device. Plastic cover 6 which protects internal parts from intrusion.

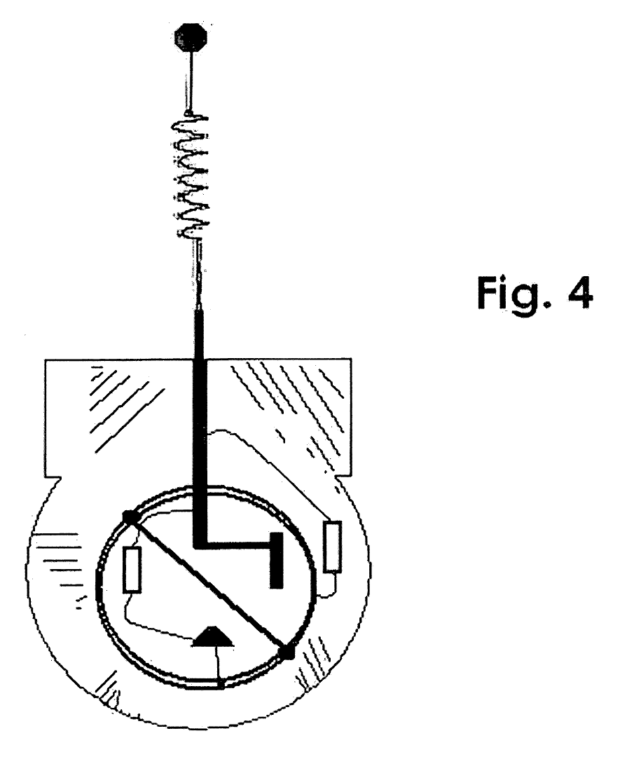

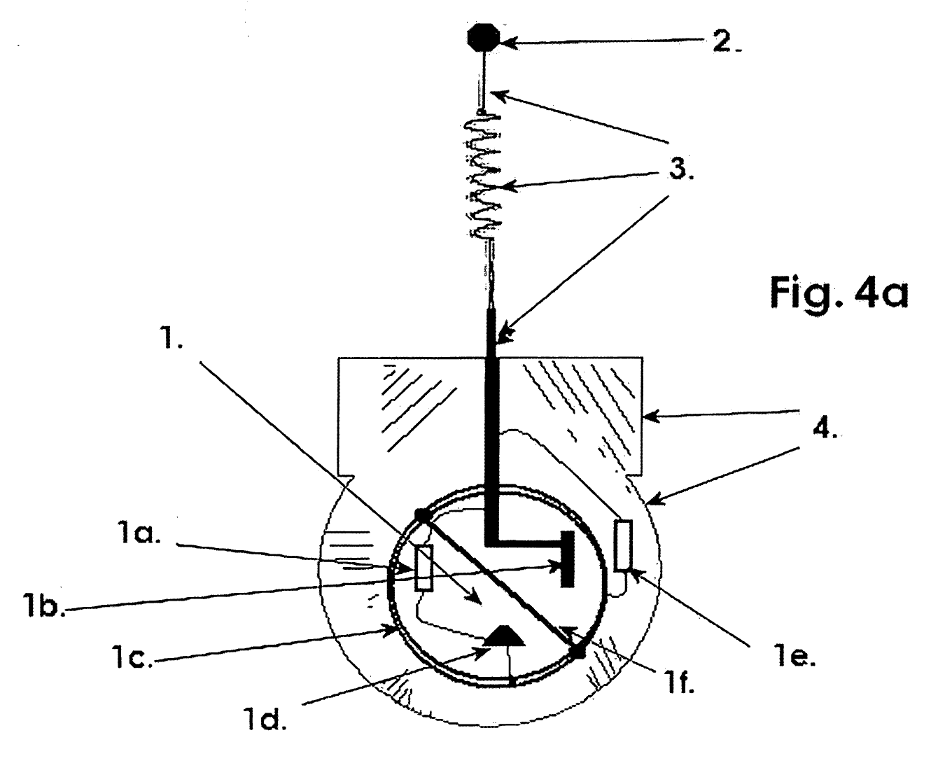

FIGS. 4 and 4a shows basic internal outlay diagram and showing the specific description of the internal parts.

1 electronic parts that are hard wired to antenna array. 1a is diode, 1b plug blade, 1c copper coil, 1d ground plug blade, 1e diode, 1f copper coil crossover of same material, 2 plastic safety ball on top of antenna. 3 standard metal antenna element, 4 basic plastic or plastic like substance for body construction of device.

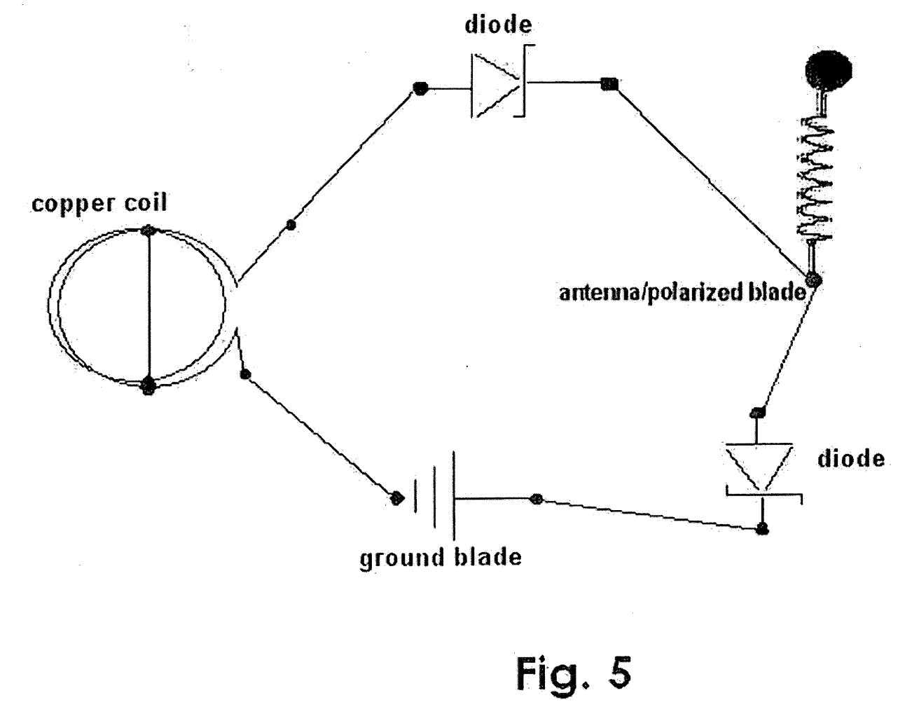

FIG. 5 is a schematic block diagram showing connections and the display of the internal electronic parts and their relationship to each other.

What is claimed is:

1. A lightweight and highly portable cell phone signal apparatus is constructed to provide a path for RF cell phone signals from outside of a building to flow into the internal part of that structure using only the buildings internal wiring infrastructure as a signal path. This apparatus provides a passive means for a standard generated RF output from a typical cellular signal outside of a structure to permeate into the interior of that structure by so means of a passive antenna provided by this device to temporarily connect to the buildings wiring infrastructure, by means of an electrical outlet as not to be permanently affixed, but plugged in as needed by the user to allow for signal source to filter into interior of current use structure. A method for operating a cell phone signal enhancer that facilitates an RF path to a cell phone which improves the cell phone input/output signal from the original source to the cell phone and delivers the improved signal to the cellular antenna, comprising: through a standard home outlet that attenuates the RF signal passing through by connecting the device antenna via the electrical outlet blades plugged directly into a standard wall outlet. The RF output is passing the signal by said device thru its external antenna to the cell phones antenna.

2. The method described in claim 1 wherein: said step of passing the cell phone output signal through this simple attenuator device includes distinct RF attenuations found in standard building infrastructure wiring. This cell phone apparatus which is constructed to provide a path to a cell phone thru its external antenna and which can enhance a cell phones receipt and transmission signal that is typically generated during a call. The cell phone signal apparatus is constructed to provide an RF path to a cell phone which can improve a cell phone input/output signal that is generated by the cell phone for transmission by it's own antenna, wherein the enhancer apparatus has a direct temporary attachment to the structure wiring via standard wall outlet to aid said cell phone input/output without being coupled directly to said device antenna; the produced gain that has a undetermined value that is solely dependent upon the output power from the cell phone itself, whereby RF signal is continuously variable. Thus, this invention provides an enhancing effect that improves operation of a cell phone by providing a signal path for the output of the cell phone that is to be transmitted, and received inside of a structure. By using a standard wall outlet this device provides a path outside of the building thus provides enhanced path RF signal from and to a receiving antenna that is delivered to the cell phone.

3. This device consisting essentially of a passive antenna, the temporarily affixes to a wall outlet for the purpose of providing an RF conduit from the exterior of a structure and allowing RF signal sources to filter through using existing wiring infrastructure, to a standard wall outlet. Thus the device affixes to the standard wall outlet and provides the RF signal pass thru to the interior of a structure for the purpose of receiving a healthier clear and/or enhanced cellular signal to reach a typical user.

4. Although particular embodiments of the invention have been described and illustrated herein, it is recognized that modifications and variations may readily occur to those skilled in the art, and consequently, it is intended that the claims be interpreted to cover such modifications and equivalents.
